(19) United States
(12) Patent Application Publication
(10) Pub. No.: US 2014/0138325 A1
(43) Pub. Date: May 22, 2014

(54) CHLORINE DIOXIDE GENERATOR

(71) Applicant: Dennis John Tomsheck, Stratford, CT (US)

(72) Inventor: Dennis John Tomsheck, Stratford, CT (US)

(21) Appl. No.: 14/078,604

(22) Filed: Nov. 13, 2013

Related U.S. Application Data
(60) Provisional application No. 61/727,275, filed on Nov. 16, 2012.

(51) Int. Cl. C01B 11/02; C02F 1/76; B01J 12/00

(52) U.S. Cl. CPC C01B 11/024; B01J 12/00; C02F 1/76
USPC 210/756; 422/606

(57) ABSTRACT

A chlorine dioxide generation system includes a process water passage formed in an integral structure proximate a first end of the integral structure. A chlorine dioxide reactor is formed in a bore of the integral structure and coupled to the process water passage. A precursor passage is formed in the integral structure proximate a second end opposite from the first end. The precursor passage has a first opening opposite a second opening coupled upstream of the chlorine dioxide reactor. First and second inlets are coupled to the precursor passage at the first and second end respectively. First and second backpressure valves are coupled to the first and second inlets respectively. First and second precursor pumps are coupled to the first and second backpressure valves respectively. A first precursor is coupled to the first precursor pump. A second precursor is coupled to the second precursor pump.

### BACKGROUND

The disclosure relates to a method and apparatus for generating chlorine dioxide.

Chlorine dioxide is a useful chemical for treating process water under various different conditions. Apparatus and methods for generating chlorine dioxide are therefore useful.

Known approaches for generating chlorine dioxide involve contact of concentrated precursors to chlorine dioxide under a vacuum created by an eductor which immediately evacuates the precursors from the reaction area and mixes them with water to prevent generation and possible decomposition of chlorine dioxide gas. Unfortunately, once the precursors are mixed with water, the conversion of the precursors to chlorine dioxide occurs slowly. Prior art generators have concentrated the chemical precursors and employ a reaction area where the chemicals briefly react under vacuum created by an eductor and are immediately evacuated from the reaction area by use of the vacuum created by the eductor and mixed with water where the conversion of the precursors to ClO₂ occurs slowly over the course of several minutes. The reaction chamber where the chemicals react is separated from the motive water by the nozzle of the eductor. This prior method creates opportunity for the formation of the chlorine dioxide gas, which is dangerous and a great problem.

The need therefore exists for methods and apparatus for generating chlorine dioxide which address this problem.

### SUMMARY

In accordance with the present disclosure, a method for generating chlorine dioxide is provided wherein a motive flow of water is used to carry chlorine dioxide solution to the ultimate use. In order to generate the chlorine dioxide, precursors such as 31% HCl and 35% NaClO₂ are fed directly to a reaction chamber which is sized, and through which flow rate is calibrated, to provide a contact time of at least of about 30 seconds before the reactants enter the motive flow of water. A reaction chamber of this size allows full reaction to chlorine dioxide before the chlorine dioxide is then mixed with process water to produce the desired chlorine dioxide solution.

As discussed below, the components which generate the motive flow of water are oriented so as to provide shut down of the system should the flow of water fail, and also to protect the components for generating the motive flow of water from back-flow of potentially corrosive chlorine dioxide when the generator is shut down. Also as discussed below, metering pumps for pumping precursors to the reaction zone are also operatively associated with components of the system for generating a motive flow of water such that the metering pumps can be shut down as well when there is insufficient flow of process water. By allowing sufficient time for complete reaction to chlorine dioxide, no aging of the resulting solution is needed. In addition, through the orientation of the components of the present disclosure, the reaction chamber is maintained in a desirably small size, and is flooded with water solution when the apparatus is shut down.

In an exemplary embodiment a chlorine dioxide generation system comprises a first precursor source fluidly coupled to a first precursor pump. A second precursor source is fluidly coupled to a second precursor pump. A chlorine dioxide reactor having a first precursor inlet is fluidly coupled to the first precursor source downstream of the first precursor pump. A second precursor inlet is fluidly coupled to the second precursor source downstream of the second precursor pump. A mixer is fluidly coupled to the chlorine dioxide reactor downstream of the chlorine dioxide reactor. The mixer is configured to homogenously mix the first precursor and the second precursor into a solution containing chlorine dioxide. The mixer is oriented for gas bubble evacuation in the absence of vacuum motive force applied to the mixer. A process water is fluidly coupled to the mixer directly downstream of the mixer, wherein the mixer is configured to directly inject the solution containing chlorine dioxide into the process water. The mixer and the chlorine dioxide reactor are configured to receive the process water for dilution of the solution containing chlorine dioxide, the first precursor, and the second precursor contained in the mixer and the chlorine dioxide reactor to prevent chlorine dioxide gas from coming out of solution. The mixer and the chlorine dioxide reactor are configured serially in a common conduit. The solution is injected into the process water in the absence of a vacuum force upstream of the mixer. The first precursor pump and the second precursor pump are configured to shut down responsive to a process water flow rate.

The chlorine dioxide reactor and the mixer are configured for complete reaction of the chlorine dioxide solution prior to mixing with the process water. The chlorine dioxide generation system further comprises at least one of a backpressure valve and check valve fluidly coupled between each of the precursor inlet and the precursor pump. The chlorine dioxide generation system includes the first precursor source comprising 25% active sodium chlorite and the second precursor comprising 31% active hydrochloric acid. The chlorine dioxide generation system has the chlorine dioxide reactor and the mixer configured to receive process water upon a shutdown of at least one of the first precursor pump and the second precursor pump.

In another exemplary embodiment a chlorine dioxide generation system comprises a process water passage formed in an integral structure proximate a first end of the integral structure. A chlorine dioxide reactor is in a bore formed in the integral structure, the chlorine dioxide reactor being fluidly coupled to the process water passage. A chlorine dioxide reactor can be serially coupled in the bore with an integral mixer. A precursor passage is formed in the integral structure proximate a second end of the integral structure opposite from the first end. The precursor passage has a first opening opposite a second opening. The precursor passage is fluidly coupled to the chlorine dioxide reactor upstream of the chlorine dioxide reactor. A first inlet is coupled to the precursor passage at the first end. A second inlet is coupled to the precursor passage at the second end. A first backpressure valve is coupled to the first inlet. A second backpressure valve is coupled to the second inlet. A first precursor pump is coupled to the first backpressure valve. A second precursor pump is coupled to the second backpressure valve. A first precursor is coupled to the first precursor pump. A second precursor is coupled to the second precursor pump.

In another exemplary embodiment the integral structure comprises a solid material and the process water passage, the chlorine dioxide reactor and the precursor passage are formed in the solid material as bores. The chlorine dioxide reactor and the precursor passage are oriented relative to gravity and configured to flow gas bubbles into the process water passage. The chlorine dioxide reactor and the precursor passage are configured to contain a volume of precursor wherein concentrated precursors are in direct contact for at least thirty seconds prior to flowing out into the process water passage. The chlorine dioxide generation system further comprises a heat exchanger thermally coupled to at least one of the chlorine dioxide reactor, and the precursor passage.

A method of generating chlorine dioxide solution is disclosed. The method includes pumping a first precursor from a first precursor source into a first precursor inlet of a precursor passage. The method includes pumping a second precursor from a second precursor source into a second precursor inlet of the precursor passage. The method includes reacting the first precursor and the second precursor in a chlorine dioxide reactor coupled downstream from the precursor passage. The method includes forming a chlorine dioxide solution in the chlorine dioxide reactor and mixing the chlorine dioxide solution with a process water in a mixer fluidly coupled downstream of the chlorine dioxide reactor and injecting the chlorine dioxide solution into the process water in the absence of a vacuum.

### BRIEF DESCRIPTION OF THE DRAWINGS

A detailed description of the present invention follows, with reference to the attached drawings, wherein:

FIG. 1 schematically illustrates a system and method in accordance with the present invention;

FIG. 2 illustrates an enlarged portion of a system in accordance with the present invention; and

FIG. 3 illustrates an alternative system in accordance with the present invention.

### DETAILED DESCRIPTION

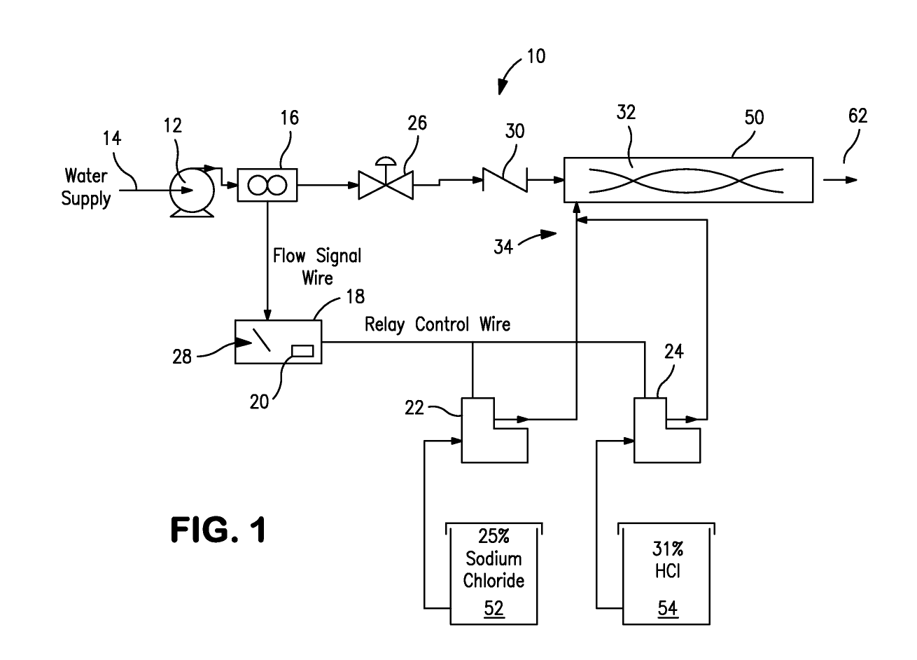

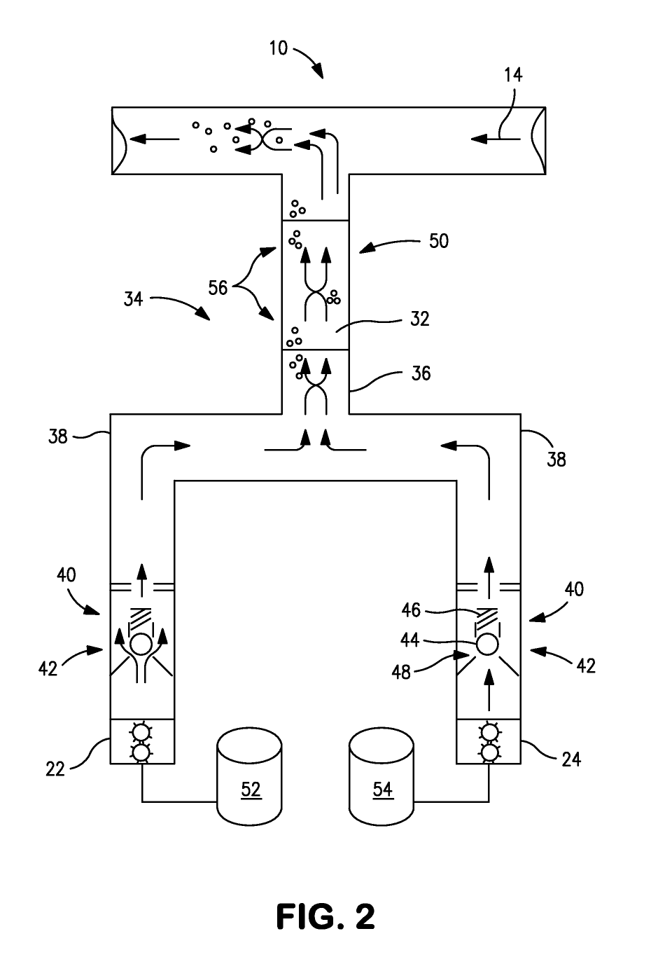

Referring to FIGS. 1 and 2 the chlorine dioxide generation system or generator 10 has a motive water pump 12 to move process water 14 through the generator 10 when there is not sufficient water pressure from the water supply to do so. When there is sufficient water pressure from the water supply being used, a motorized ball valve is employed to allow water through the generator when in operation and to shut off the flow of water though the generator when not in use. If a motive water pump 12 is employed, a basket strainer (not shown) is installed prior to the pump to prevent damage to the pump from debris or large solids in the water supply.

Following the pump 12 or motorized ball valve is paddle wheel flow sensor or flow sensor 16. The flow sensor 16 is installed in a vertical length of pipe with a sufficient straight run of pipe before and after the flow sensor 16 to insure laminar flow for accurate flow measurement. The flow sensor 16 is connected to a flow measurement instrument 18 (flow meter/flow transmitter) with programmable relay 20 that uses the signal from the flow sensor 16 to measure the flow of process water 14 through the generator 10. The relay 20 is configured such that it will turn the generators first and second precursor pumps 22, 24 off should the flow of water 14 through the generator 10 drop below a specific flow rate. In one example, if the flow rate drops below 2 gallons per minute, the relay 20 can signal the first precursor pump 22 and second precursor pump 24 to stop. The relay state that turns the precursor pumps 22, 24 on/off should be arranged such that if power was lost to the flow sensor 16, the pumps 22, 24 would shut off. This is the primary safety interlock on the generator 10, preventing precursor from being added to the system unless there is sufficient process water 14 flowing to dilute and carry the produced chlorine dioxide from the generator 10.

A paddle wheel sensor 16 is used because if it fails, it will fail to show less than actual or zero flow, thereby shutting off the precursor pumps 22, 24.

After the paddle wheel flow sensor 16 is a flow throttling diaphragm valve or throttle valve 26. The throttle valve 26 can be installed a sufficient length from the sensor 16 such that the throttle valve 26 does not interfere with the accurate operation of the flow sensor 16. The flow throttling valve 26 allows the operator of the generator 10 to dial in a specific flow rate through the generator 10, if so desired. Viewing a readout 28 from the flow meter 16 while adjusting the flow throttling valve 26 will allow the operator to set a specific flow and also check the operation of the safety interlock in the instrument 18 by adjusting flow below the low flow set point and observing whether or not the precursor pumps 22, 24 shut off.

After the flow throttling valve 26 is a spring loaded check valve or check valve 30. The purpose of the spring loaded check vale 30 is to protect the components prior to the check valve 30 from corrosive chlorine dioxide solution 32 when the generator 10 is turned off. Without a check valve 30 at this location, when the generator 10 was turned off, chlorine dioxide solution 32 further downstream would permeate back through the piping, possibly shortening the service life of upstream components due to its corrosive nature. After the spring loaded check valve 30 is the chlorine dioxide reactor 34.

As seen in more detail at FIG. 2, in an exemplary embodiment, the chlorine dioxide reactor 34 consists of a tee 36 coupled to two 90 degree elbow fittings 38. In an exemplary embodiment, the tee 36 can be a one half inch Kynar™ tee with two one half inch Kynar™ 90 degree elbows. Each Kynar™ 90 degree elbow 38 is fitted with a ½″ Kynar female adaptor to allow an injector 40 to be coupled to the elbow 38.

In an exemplary embodiment, the injector 40 can include a Kynar™ injector 40 (i.e., injection quill) to be screwed into each female adaptor. The injector 40 can be made of solid Kynar™ with one half inch male pipe threads and have a spring loaded check valve 42 to prevent flow back into the chemical supply tubing (from the two precursor pumps 22, 24). In an exemplary embodiment, the check valve 42 can have a ceramic check ball 44, Hasetloy™ C-270 spring 46 and removable Kynar™ valve seat 48 for the ball check valve 42.

A static mixer 50 is fluidly coupled to the chlorine dioxide reactor 34. The static mixer 50 is configured to homogeneously mix a first precursor 52 with a second precursor 54 into a solution containing chlorine dioxide (chlorine dioxide solution 32). In an exemplary embodiment, the static mixer 50 is configured as a one inch Kynar™ tube with thick walls.

The static mixer 50 can be oriented vertically and the other components oriented such that the tee 36 with elbows 38 are at a lower elevation relative to gravity than the mixing chamber 50 so that any bubbles of chlorine dioxide gas 56 that may form will travel upward and out of the chlorine dioxide reactor 34 through the static mixer 50 and into the process water stream 14 flowing through the static mixer 50.

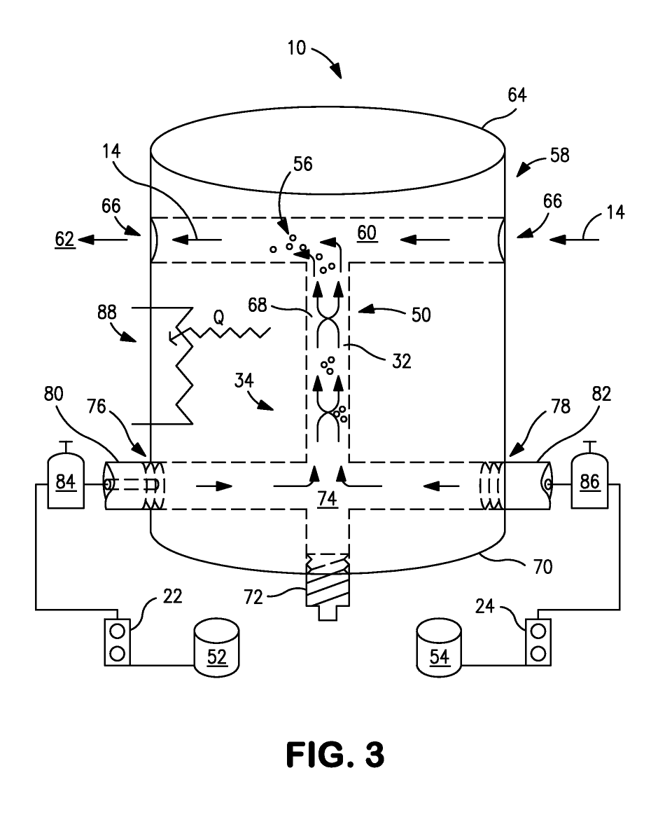

In an exemplary embodiment, the total volume of the reactor 34 and mixer 50, shall be such that at maximum precursor feed rate, there will be at least a thirty second contact time prior to spilling out into the generator's water flow. As the concentrated precursors react, they will form a concentrated solution of chlorine dioxide and water (chlorine dioxide solution 32) (wherein water is the dilutant used to put the precursor chemicals 52, 54 in solution). The chlorine dioxide reactor 34 is designed such that there is no area for chlorine dioxide gas 56 to come out of solution. It will be pushed out of the chlorine dioxide reactor 34 as a concentrated solution and diluted with the process water 14 as illustrated in FIGS. 2 and 3. When the generator 10 is shut off, the remaining concentrated solution 32 will be diluted by the water in the static mixer 50 as water 14 permeates into the reactor 34.

By not allowing chlorine dioxide to be present as a gas, the chlorine dioxide cannot decompose. A secondary safety feature is, by keeping the reactor 34 volume small, even if there were to be a decomposition, the amount of reactant would be small and therefore less dangerous than a reaction with large amounts of reactant.

The generator 10 is designed to use concentrated precursors, specifically, the first precursor 52 can comprise 25% active sodium chlorite and the second precursor 54 can comprise 31% active hydrochloric acid (HCL), other concentrated acids such as phosphoric or citric acid may be substituted for the HCl. Sodium chlorate and peroxide may be substituted for 25% active sodium chlorite. By allowing the concentrated precursors 52, 54 in the generator 10 of the present disclosure to be in direct contact for thirty seconds or more before being pushed out into the process water 14 the reactor 34 is directly connected to, the reaction occurs quickly and fully, eliminating the need for further “aging” of the resultant solution. By having the reactor 34 directly in contact with the process water 14, there is no “air space” where concentrated ClO₂ solution can off gas chlorine dioxide gas 56 thereby eliminating the possibility of the gas decomposing. When the generator 10 shuts off, water will permeate into the reactor 34 and dilute the mix of chemicals, keeping the resultant chlorine dioxide safely in solution within the system.

To accommodate feeding the two precursors 52, 54 into the chlorine dioxide reactor 10, two chemical metering pumps or the first precursor pump 22 and second precursor pump 24 can be employed. The individual pumps will be of materials and construction that are compatible with the precursor being pumped. The pumps 22, 24 will have a remote start/stop feature allowing a dry contact relay on the generator's water meter 16 to turn the pumps 22, 24 on when there is sufficient process water 14 flows to operate and off when there is not sufficient flow to operate. Each pump can be calibrated for the liquid it will pump and have an adjustment to vary the amount of precursor being fed either in milliliters per minute (ml/min) or gallons per day (g/day), thereby allowing the generator operator to adjust the amount of chlorine dioxide being produced. A chart can be provided equating the ml/min or gal/day settings of each precursor to pounds per hour or pounds per day of chlorine dioxide produced. In an exemplary embodiment, high pressure Teflon® chemical tubing will be used to connect the chemical metering pumps to the reactor 34.

In an exemplary embodiment shown in FIG. 3, the chlorine dioxide generator 10 can include the chlorine dioxide reactor 34 formed in an integral structure 58. The integral structure 58 can be formed as a cylinder from a solid material. In an exemplary embodiment, the cylinder structure 58 can be six inches in diameter and have a length of about one foot. The integral structure 58 can comprise a solid grey PVC material. Other material composition of the integral structure 58 can include materials resistant to the thermal and chemical environment created by the chlorine dioxide generator 10 and the resultant chemical reactions of the precursors 52, 54 in the chlorine dioxide reactor 34.

The integral structure 58 includes a process water passage 60. The process water passage 60 is configured to couple the chlorine dioxide generator 10 to the process water 14, such that the process water 14 flows through the generator 10 receives an injection of chlorine dioxide solution 32 and flows to a downstream process destination 62. The process water passage 60 can comprise a bore through the integral structure 58. The process water passage 60 can be a one inch diameter bore drilled radially through a first end 64 of the integral structure 58. The process water passage 60 bore can include threaded features at openings 66 formed at opposite ends of the process water passage 60. The threaded features accommodate coupling to the process water 14 pipe system. The bore of the process water passage 60 can be located in the integral structure 58 such that the wall thickness of the passage 60 is sufficiently thick enough to endure the thermal and chemical environment produced within the chlorine dioxide generator 10. In an exemplary embodiment the process water passage 60 has a wall thickness of about one inch. It is contemplated that this wall thickness dimension can be adjusted to suite the material composition of the integral structure 58 and chemical reactions of the precursors 52, 54 within.

The static mixer or mixer 50 of the chlorine dioxide generator 10 can be formed within the integral structure 58. The mixer 50 can be integrated into the chlorine dioxide reactor 34 and formed as a portion of a bore 68 through the integral structure 58 along the axis of the integral structure 58. In another exemplary embodiment, the mixing function is performed within the chlorine dioxide reactor 34. The reactor 34 is coupled to the process water passage 60, allowing for fluid flow between the reactor 34 and water passage 60. In an exemplary embodiment, the bore 68 of the reactor 34 can be one half inch in diameter. The bore 68 can be created by drilling from a second end 70 of the integral structure 58.

A plug 72 is inserted into the bore 68 of the mixer 50 proximate the second end 70. The plug 72 functions to cap off the bore 68 to contain the fluids of the chlorine dioxide generator 10. The plug 72 can be machined from PVC and include threads that thread into the bore 68 at the second end 70.

An additional passage, a precursor passage 74 can be formed in the integral structure 58. The precursor passage 74 can accommodate the flow of precursors from each of the first and second precursor pumps 22, 24. The precursor passage 74 can be formed similarly to the process water passage 60 as a bore through the integral structure 58. The precursor passage 74 can be a one inch diameter bore drilled radially through the integral structure 58 proximate to the second end 70 of the integral structure 58. The precursor passage 74 can include threaded features at first and second openings 76, 78 formed at opposite ends of the precursor passage 74. The threaded features accommodate coupling to the first and second precursor pumps 22, 24. The bore of the precursor passage 74 can be located in the integral structure 58 such that the wall thickness of the precursor passage 74 is sufficiently thick enough to endure the thermal and chemical environment produced within the chlorine dioxide generator 10. In an exemplary embodiment, the precursor passage 74 has a wall thickness of about one inch. It is contemplated that this wall thickness dimension can be adjusted to suite the material composition of the integral structure 58 and chemical reactions within. The process water passage 60 and the precursor passage 74 are parallel to each other and fluidly coupled by the reactor 34 via bore 68.

A first precursor inlet or nipple 80 is coupled to the precursor passage 74 at first opening 76. A second precursor inlet or nipple 82 is coupled to the precursor passage at second opening 78 opposite the first opening 76 of the precursor passage 74. In an exemplary embodiment, the first nipple 80 and second nipple 82 can be fabricated out of solid Halar™ ECTFE. The nipples 80, 82 include a robust wall thickness capable of being durable in the thermal and chemical environment of the precursors 52, 54. In an exemplary embodiment, the nipples 80, 82 can have a wall thickness of about ⅜ inch and can be about 1¾ inches in length.

A first backpressure valve 84 is coupled to the first nipple 80 upstream of the first nipple 80. The first backpressure valve 84 can be adjustable and constructed from materials, such as PVC with a Teflon™ diaphragm, resistant to the precursor chemicals. The first backpressure valve 84 can include an adjustable backpressure range of about 25 psi to about 250 psi (pounds per square inch). A second backpressure valve 86 is coupled to the second nipple 82 upstream of the second nipple 82. The second backpressure valve 86 has similar properties and characteristics as the first backpressure valve 84.

The first and second precursor pumps 22, 24 can be fluidly coupled to the each respective backpressure valve 84, 86 via chemical resistant tubing, such as Teflon™ tubing and Kynar™ compression fittings with sufficient pressure ratings compatible with the system pressures. In an exemplary embodiment, the pressure rating can be about 150 psi to feed the two precursors 52, 54 into the reactor 34. In an exemplary embodiment, the pumps 22, 24 include a maximum pressure rating/flow rating of 150 psi and 8 liters per hour. The pumps 22, 24 are configured to be compatible with the chemicals used in the generator 10, such as, for 25% active sodium chlorite at 20 Baume hydrochloric acid. The pumps can be configured to accurately meter adjust precursor flow rates to control the production of the ClO₂ and to be shut down by a relay, such as a dry contact relay. The generator 10 can be coupled to the process water 14 via a one inch water supply, such as a schedule 80 PVC.

In operation, the generator 10 functions to control the feed of concentrated precursors 52, 54 into the precursor passage 74 by the pumps 22, 24. The precursors 52, 54 combine mix and react in the reactor 34 to form a high strength solution of ClO₂ 32. The solution 32 is forced up into the process water 14 by continuous precursor pumping into the precursor passage 74. The high strength solution 32 is diluted by the process water 14 and carried off to an application point such as the process water destination 62. The process water flow 14 is of sufficient volume so that during operation of the precursor pumps 22, 24 at maximum capacity, the strength of diluted ClO₂ solution 32 is about 3000 parts per million or less. As a safety feature, the generator 10 has the relay 20 interlocked with the pumps 22, 24 to automatically shut down pumping if the process water flow drops below the volume needed to insure the solution 32 strength discharging from the generator 10 to be 3000 ppm or less at a maximum production rate.

Further enhancing the safety of the generator 10, is the configuration of the generator 10 such that upon production shut down, process water 14 can permeate into the mixer 50 and reactor 34 from the process water passage 60. With the bore 68 being oriented vertically, relative to gravity, the buoyancy of any gases, such as bubbles or chlorine dioxide gas 56, will force the gas bubbles 56 out of the reactor 34 and into the process water passage 60 to dissolve into solution with the process water 14.

One or more embodiments have been described. Nevertheless, it will be understood that various modifications may be made. For example, it is contemplated in an alternative embodiment that the unique construction of the generator 10 allows for larger capacity sized generators to be assembled. The size of the precursor pumps, 22, 24, process water passage 60, reactor 34 and precursor passage 74, along with the fittings 80, 82, and valves 84, 86 can be adjusted following the same design principles. Thicker wall design, thermal material properties and chemical resistance can be factored into the generator 10. Additionally, the integral structure 58 can include at least one heat exchanger 88 configured to remove thermal energy Q generated by the chemical reactions of the generator 10. The heat exchanger 88 can include a variety of designs, such as, water jacket, convective fluids, conductive materials, fins, tubes, and the like. The heat exchanger 88 can be thermally coupled to the reactor 34, mixer 50 to transfer thermal energy Q to maintain proper operating temperatures of the generator 10. The integral structure 58 can be constructed from a composite material that incorporates the necessary mechanical, chemical and thermal properties necessary to durably function in the environment of the generator 10. Accordingly, other embodiments are within the scope of the following claims.

What is claimed is:

1. A chlorine dioxide generation system comprising:
a first precursor source fluidly coupled to a first precursor pump;
a second precursor source fluidly coupled to a second precursor pump;
a chlorine dioxide reactor having a first precursor inlet fluidly coupled to said first precursor source downstream of said first precursor pump and a second precursor inlet fluidly coupled to said second precursor source downstream of said second precursor pump;
a mixer fluidly coupled to said chlorine dioxide reactor downstream of said chlorine dioxide reactor, said mixer configured to mix said first precursor and said second precursor into a solution containing chlorine dioxide, said mixer oriented for gas bubble evacuation in the absence of vacuum motive force applied to said mixer; and
a process water fluidly coupled to said mixer directly downstream of said mixer, wherein said mixer is configured to directly inject said solution containing chlorine dioxide into said process water, wherein said mixer and said chlorine dioxide reactor are configured to receive said process water for dilution of said solution containing chlorine dioxide, said first precursor, and said second precursor contained in said mixer and said chlorine dioxide reactor to prevent chlorine dioxide gas from coming out of solution.

2. The chlorine dioxide generation system of claim 1, wherein said mixer and said chlorine dioxide reactor are configured serially in a common conduit.

3. The chlorine dioxide generation system of claim 1, wherein said solution is injected into said process water in the absence of a vacuum force upstream of said mixer.

4. The chlorine dioxide generation system of claim 1, wherein said first precursor pump and said second precursor pump are configured to shut down responsive to a process water flow rate.

5. The chlorine dioxide generation system of claim 1, wherein said chlorine dioxide reactor and said mixer are configured for complete reaction of said chlorine dioxide solution prior to mixing with said process water.

6. The chlorine dioxide generation system of claim 1, further comprising at least one of a backpressure valve and check valve fluidly coupled between each of said precursor inlet and said precursor pump.

7. The chlorine dioxide generation system of claim 1, wherein said first precursor source comprises 25% active sodium chlorite and said second precursor comprises 31% active hydrochloric acid.

8. The chlorine dioxide generation system of claim 1, wherein said chlorine dioxide reactor and said mixer are configured to receive process water upon a shutdown of at least one of said first precursor pump and said second precursor pump.

9. A chlorine dioxide generation system comprising:
a process water passage formed in an integral structure proximate a first end of said integral structure;
a chlorine dioxide reactor in a bore formed in said integral structure, said a chlorine dioxide reactor being fluidly coupled to said process water passage;
a precursor passage formed in said integral structure proximate a second end of said integral structure opposite from said first end, said precursor passage having a first opening opposite a second opening, said precursor passage fluidly coupled to said chlorine dioxide reactor upstream of said chlorine dioxide reactor;
a first inlet coupled to said precursor passage at said first end;
a second inlet coupled to said precursor passage at said second end;
a first backpressure valve coupled to said first inlet;
a second backpressure valve coupled to said second inlet;
a first precursor pump coupled to said first backpressure valve;
a second precursor pump coupled to said second backpressure valve;
a first precursor coupled to said first precursor pump; and
a second precursor coupled to said second precursor pump.

10. The chlorine dioxide generation system of claim 9, wherein said integral structure comprises a solid material and said process water passage, said chlorine dioxide reactor and said precursor passage are formed in said solid material as bores.

11. The chlorine dioxide generation system of claim 9, wherein said chlorine dioxide reactor and said precursor passage are oriented relative to gravity configured to flow gas bubbles into said process water passage.

12. The chlorine dioxide generation system of claim 9, said wherein said chlorine dioxide reactor and said precursor passage are configured to contain a volume of precursor wherein concentrated precursors are in direct contact for at least thirty seconds prior to flowing out into said process water passage.

13. The chlorine dioxide generation system of claim 9, further comprising:
a heat exchanger thermally coupled to at least one of said chlorine dioxide reactor, and said precursor passage.

14. A method of generating chlorine dioxide solution comprising:
pumping a first precursor from a first precursor source into a first precursor inlet of a precursor passage;
pumping a second precursor from a second precursor source into a second precursor inlet of said precursor passage;
reacting said first precursor and said second precursor in a chlorine dioxide reactor coupled downstream from said precursor passage;
forming a chlorine dioxide solution in said chlorine dioxide reactor; and
injecting said chlorine dioxide solution into said process water in the absence of a vacuum.

15. The method of claim 14 further comprising:
preventing the formation of chlorine dioxide gas out of said chlorine dioxide solution.

16. The method of claim 14 further comprising:
homogeneously mixing said chlorine dioxide solution into a process water in the absence of vacuum motive force applied to said chlorine dioxide reactor.

17. The method of claim 14 further comprising:
upon a precursor pump shutdown condition, permeating water into said chlorine dioxide reactor, and said precursor passage; and
diluting the chlorine dioxide solution in a concentration resulting in a stable chlorine dioxide solution such that chlorine dioxide gas cannot come out of said chlorine dioxide solution.

18. The method of claim 14 further comprising:
interlocking said first and second precursor pumps with a relay coupled to a flow sensor; and
shutting down said first and second precursor pumps responsive to a process water flow rate.

19. The method of claim 14 further comprising:
orienting said process water passage, said chlorine dioxide reactor and said precursor passage relative to gravity, such that the buoyancy of any gases forces the gas bubbles out of the precursor passage, and the chlorine dioxide reactor, into the process water passage to dissolve into solution with the process water.
